(19) United States
(12) Patent Application Publication
(10) Pub. No.: US 2007/0202321 A1
(43) Pub. Date: Aug. 30, 2007

(54) Thermally conductive microporous coating

(75) Inventors: Seung Mun You, Arlington, TX (US); Joo Han Kim, Fort Worth, TX (US)

Correspondence Address: Fernandez & Associates, LLP, PO Box D, Menlo Park, CA, 94025-6204, US

(73) Assignee: Board of Regents, The University of Texas System, Austin, TX (US)

(21) Appl. No.: 11/272,332

(22) Filed: Nov. 9, 2005

(51) Int. Cl. B32B 5/16

(52) U.S. Cl. 428/328

(57) ABSTRACT

A microporous surface is created using particles of various sizes in conjunction with a thermally conductive binder. Advantages to a mixture batch type application of the coating include that it is an inexpensive and easy process which does not require extremely high operating temperatures. The disclosed coating technique is efficient for various types of working liquids simply by changing the size of metal particle sizes since different surface tension of liquids requires different size range of porous cavities to optimize boiling heat transfer performance. In one embodiment, the coating is applied to an electronic component surface.

### FIELD OF THE INVENTION

Invention relates to boiling heat transfer from a surface to a liquid, particularly to surface enhancements to increase the density of boiling nucleation sites.

### BACKGROUND OF INVENTION

Various surface enhancement techniques have been previously investigated by researchers to augment nucleate boiling heat transfer coefficient and to extend the critical heat flux (CHF, or the highest heat flux that can be removed without exposing the surface to film boiling), and the techniques have been commercialized to maximize boiling heat transfer performance. Commercial surfaces for boiling enhancement include different types of cavities or grooves such as Furukawa's ECR-40, Wieland's GEWA, Union Carbide's High-Flux, Hitachi's Thermoexcel, and Wolverine's Turbo-B. The surface enhancement techniques are to increase vapor/gas entrapment volume and thus to increase active nucleation site density.

One of the recent methods suggested by You and O'Connor (1998) to produce an enhanced boiling surface microstructure was microporous surface structures. The microporous coating has developed into an enhancement technique that is benign enough to apply directly to electronic chip surfaces. The microporous coating provides a significant enhancement of nucleate boiling heat transfer and CHF while reducing incipient wall superheat hysteresis. One option of the microporous coating is ABM coating technique developed by You and O'Connor (1998) (U.S. Pat. No. 5,814,392). The coating is named from the initial letters of their three components (Aluminum/Devcon Brushable Ceramic/Methyl-Ethyl-Keytone). After the carrier (M.E.K.) evaporates, the resulting coated layer consists of microporous structures with aluminum particles (1 to 20 μm) and a glue (Omegabond 101 or Devcon Brushable Ceramic) having a thickness of ≈50 μm, which was shown as an optimum thickness for FC-72. The boiling heat transfer advantages of the non-conducting microporous coating method can be improved by replacing the non-thermally conducting glue with a thermally conducting binder.

The microporous surfaces can be thermally conducting when sintering process is used and the sintered surfaces are known to generate highly effective porous surface for boiling heat transfer; however it is known to be an expensive and sensitive process which requires extremely high operating temperatures. There exists a need for a microporous surface with a thermally conductive binder that can be produced inexpensively and easily.

### SUMMARY OF INVENTION

The current invention combines the advantages of a mixture batch type and thermally-conductive microporous structures. Advantages to the mixture batch type application include that it is an inexpensive and easy process which does not require extremely high operating temperatures. The surface is also relatively insensitive to coating thickness due to the high thermal conductivity of the binder. In the various embodiments of the invention, the microporous surface is created using particles of various sizes comprising nickel, copper, aluminum, silver, iron, brass and various alloys in conjunction with a thermally conductive binder. In order to compare the boiling performance between the current invention, Thermally-Conductive Microporous Coating (TCMC), and ABM, the boiling experiments of ABM in saturated FC-72 and water were conducted and compared.

### BRIEF DESCRIPTION OF DRAWINGS

FIG. 1A is a SEM image of Thermally-Conductive Microporous Coating structures using −325 mesh (8-12 μm) nickel particles.

FIG. 1B is a SEM image of Thermally-Conductive Microporous Coating structures using −100+325 mesh (30-50 μm) nickel particles.

FIG. 1C is a SEM image of Thermally-Conductive Microporous Coating structures using −50+100 mesh (100-200 μm) nickel particles.

FIG. 2 is the pool boiling test facility.

FIG. 3 is the test heater.

FIG. 4 is a boiling results comparison with ABM coating for particle size of −100+325 mesh (30-50 μm) in saturated FC-72.

FIG. 5 is a boiling results comparison with ABM coating for particle size of −100+325 mesh (30-50 μm) in saturated water at 60° C.

FIG. 6 is a boiling results comparison with plain surface for three different particle sizes in saturated FC-72 at atmospheric pressure.

FIG. 7 is a boiling results comparison with plain surface for three different particle sizes in saturated water at 100° C.

### DETAILED DESCRIPTION OF THE INVENTION

The current invention is an improvement from non-conductive microporous coating using a non-thermally conducting glue to bind cavity-generating particles. While commercial surface enhancement techniques use cavities or grooves to increase active nucleation sites, this invention uses microporous surface structures for boiling enhancement. In one embodiment, the coating is applied to an electronic component surface.

In the various embodiments of the invention, the microporous surface is created using particles of various sizes comprising any metal which can be bonded by the soldering process including nickel, copper, aluminum, silver, iron, brass and various alloys in conjunction with a thermally conductive binder. The coating is applied while mixed with a solvent. In one embodiment, the solvent is vaporized after application to a surface prior to heating the surface sufficiently to melt the binder to bind the particles.

Advantages to the mixture batch type application include that it is an inexpensive and easy process which does not require extremely high operating temperatures. The surface is also relatively insensitive to coating thickness due to the high thermal conductivity of the binder. Therefore, larger size cavities can be constructed in the microporous structures for poorly wetting fluids (such as water) without causing serious degradation of boiling enhancement. For that reason, the new coating technique is efficient for various types of working liquids simply by changing the size of metal particle sizes since different surface tension of liquids requires different size range of porous cavities to optimize boiling heat transfer performance.

In one embodiment of the invention the thermally-conducting binder comprises solder paste that bonds the metal particles together in order to produce numerous microporous cavities on a target surface. The solvent may be chosen from the group comprising ethyl alcohol, isopropyl alcohol, acetone, methylethyl ketone (MEK), FC-72, FC-87, or similar highly evaporative solvent.

The method of applying the coating described to a surface includes creating a uniform mixture of the cavity-generating particles, the thermally conductive binder, and the solvent using, for example, an ultrasonic bath. The mixture is then applied to the surface using a method such as brushing, painting, spraying, vibrating, dipping the surface into the mixture, dripping, splatter, rotating the surface while dripping, or other methods known in the art. The treated surface is then heated to a temperature sufficient to vaporize the solvent. The surface is then further heated to a temperature sufficient to melt the solder paste such that it serves as a binder between the cavity generating particles. During this process, solder flux is used to expedite formation of micropores during the bonding process between the particles and later removed from the surface.

The following embodiments are included to demonstrate preferred embodiments of the invention. It should be appreciated by those of skill in the art that the techniques disclosed in the examples which follow represent techniques discovered by the inventors to function well in the practice of the invention, and thus to constitute the more preferred known modes for its practice. However, those of skill in the art should, in light of the present disclosure, appreciate that many changes can be made in the specific embodiments which are disclosed and still obtain a like or similar result without departing from the spirit and scope of the invention.

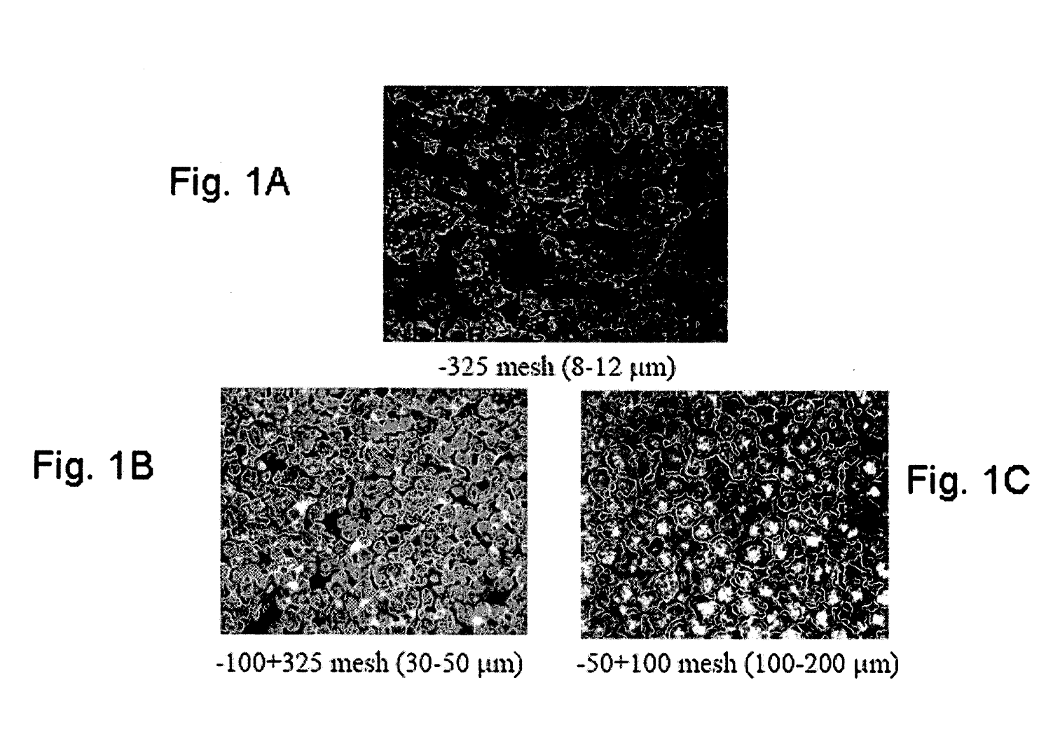

FIGS. 1A, 1B and 1C are SEM (Scanning Electron Microscope) images for thermally conducting microporous surfaces in three alternative embodiments of the invention where the solder pastes are seen as a binder between nickel particles and resultantly produce numerous microporous cavities. In these embodiments, the cavity-generating particles comprise nickel particles, which are highly resistant to atmospheric corrosion and to most acids. While in these examples, round particles were used, it is within the scope of this invention that other particle shapes be used. The thermally-conducting binder in these embodiments is solder paste, and the solvent used was 10 ml ethyl alcohol. The coating mixture was applied to a target surface using a normal art (soft type) paintbrush.

FIG. 1A illustrates one embodiment in which 1 gram of −325 mesh nickel powder (having a particle size of 8 to 12 μm) was mixed with 0.8 grams of premixed solder paste.

FIG. 1B illustrates a second embodiment in which 1 gram of −100+325 mesh nickel powder (having a particle size of 30 to 50 μm) was mixed with 0.5 grams of premixed solder paste.

FIG. 1C illustrates a third embodiment in which 1 gram of −50+100 mesh nickel powder (having a particle size of 100 to 200 μm) was mixed with 0.5 grams of premixed solder paste.

Experimental Boiling Data of the Invention

In order to compare the boiling performance between the current invention, Thermally-Conductive Microporous Coating (TCMC), and ABM (non-conducting binder method developed by You and O'Connor (U.S. Pat. No. 5,814,392), the boiling experiments of ABM in saturated FC-72 and water were conducted and compared. The boiling results of ABM were plotted with TCMC boiling results in same graphs for better comparison.

Pool Boiling Test Facility

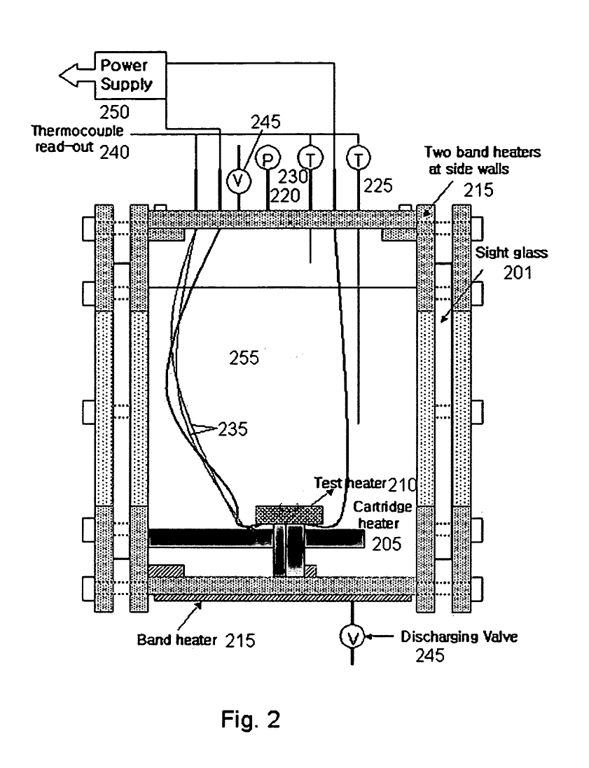

The schematic of the pool boiling test facility is shown in FIG. 2. The entire test apparatus was made of aluminum for the reduction of a total weight. The reinforced sight glasses 201 were equipped at the front and rear sides of the test module for the view ports. For the rapid heating, two cartridge heaters 205 were immersed below a test heater 210. The band heaters 215 were attached at both sides and bottom of the vessel in order to maintain the steady condition of the boiling fluid. The internal pressure was measured with an absolute pressure transducer 220, DRUCK PTX-1400, which has ranges of 0-2.5 bar and accuracy of 0.25% in full scale for 60° C. saturated experiments. For the measurements of liquid and vapor temperatures T-type probe thermocouples 225 and 230, respectively, were employed. Two T-type thermocouples 235 were used to measure the wall temperature. The temperature data was transmitted by the thermocouple read-out 240. The pool boiling test facility included two valves 245, for controlling the internal pressure.

Test Heater

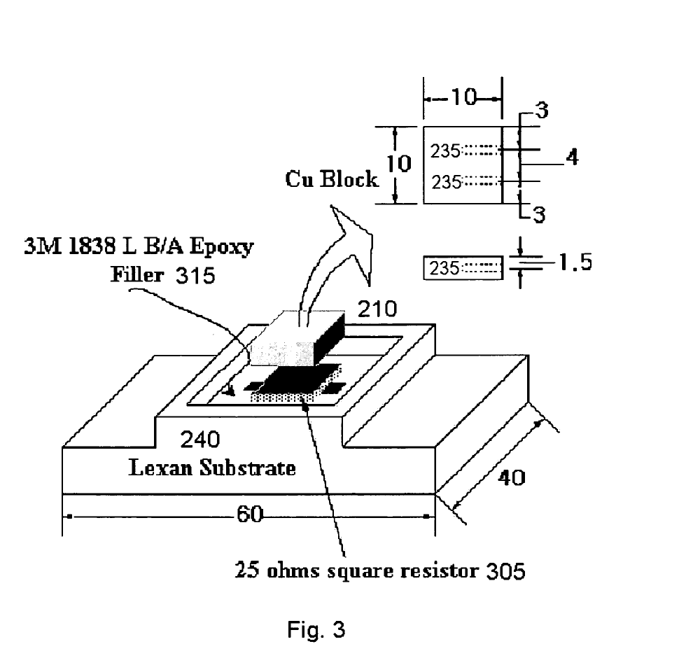

The test heater 210 was manufactured using 25-ohms square resistor 305 (Component General Co.) for the heating element as shown in FIG. 3. The 10 mm×10 mm×3 mm copper block 310 was soldered to the heating element, and the 1838 L B/A epoxy 315 by 3M Co. was filled around the copper block and the resistor for the insulation. In order to measure the wall temperature, two T-type thermocouples 235 were inserted at 1.5 mm below the upper surface of the copper block. From the measured temperatures, the wall temperature can be calculated assuming one-dimensional heat conduction through the copper block. The test heater was mounted on a Lexan substrate 240.

Experimental Procedure

After test liquids 255 are filled in the test section, the cartridge heaters 205 are heating test liquids up to saturated temperature at atmospheric pressure (or 2.89 psi for additional water test). When the fluid temperature reaches the saturated temperature, the cartridge heaters 205 are turned off, and the band heaters 215 are turned on. With a valve 245 open, test liquids temperature maintains at saturated condition or a little higher. Maintaining this condition during one hour, the non-condensable gases in test liquids 255 can be vented completely. During degassing process, a glass condenser is set up to maintain the original amount of test liquids. For 60°-saturated water test, the valve 255 is closed from the outside after degassing process. Then the bulk temperature of the water was reduced and maintained at 60° corresponding to the saturated pressure of 2.89 psia with an aid of a temperature controller connected to the silicon rubber heaters. A DC power supply 250 (Agilent 6030A) supplied power to the test heater and all data including internal pressure, fluid temperature, vapor temperature and heater wall temperature are measured with a data acquisition system (Agilent 3852A). If the wall temperature rapidly increased over 20° than the previous average value for an incremental heat flux increase, it is assumed that CHF occurs and power is cut off automatically. The middle value between the previous power and the present power is saved as the CHF.

Experimental Boiling Data of the Invention

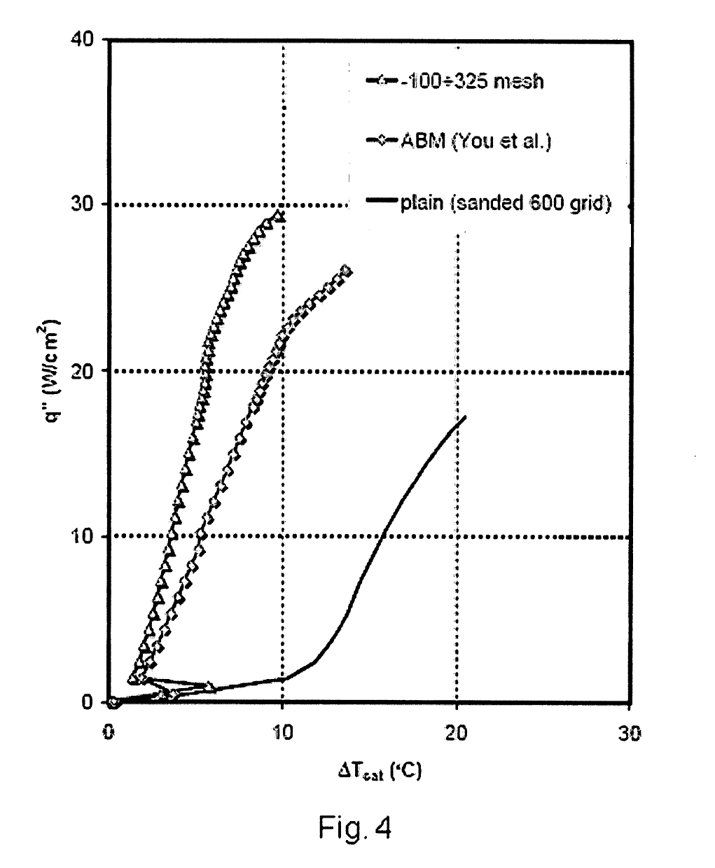

FIG. 4 shows the boiling performance comparison between 30-50 μm TCMC and ABM coating for saturated FC-72. The results showed that both ABM and TCMC generated the substantial enhancement of nucleate boiling heat transfer and CHF over a sand-roughened surface. It is clearly observed that TCMC generates additional enhancement of nucleate boiling heat transfer rate (up to ˜80%) and CHF (˜10%) over ABM coating. This boiling enhancement could be possibly achieved due to the thermally conducting binders, which generate very low thermal resistance at high heat flux compared to non-conducting binders.

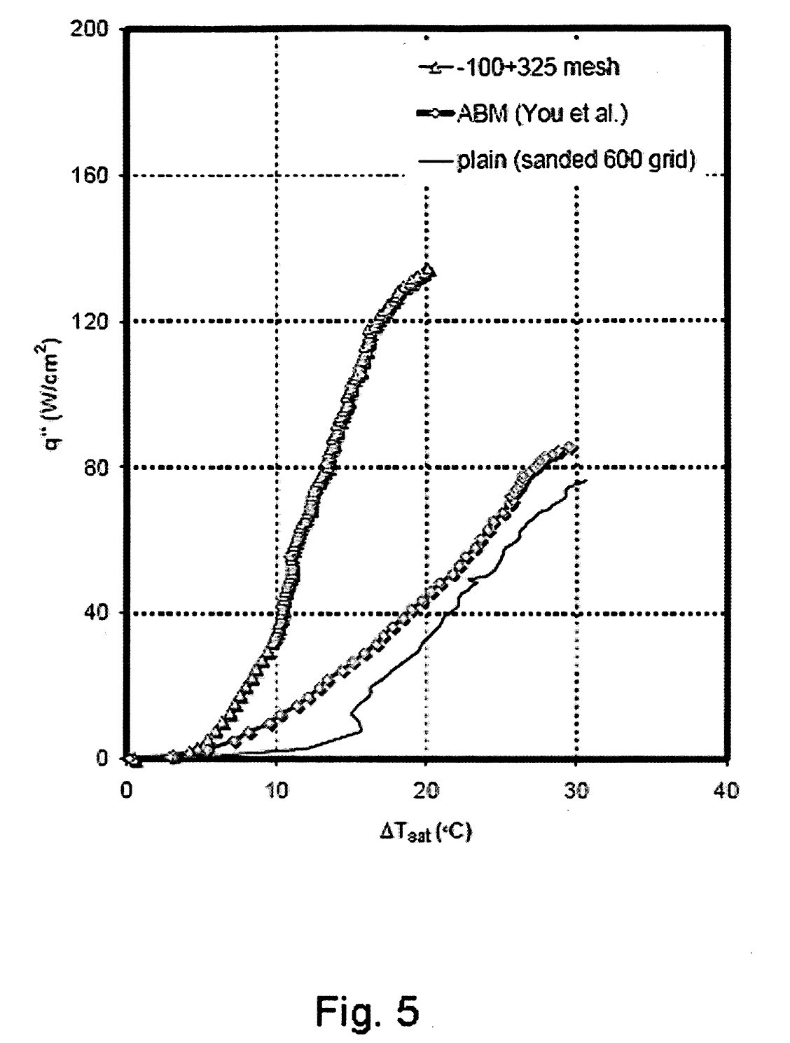

FIG. 5 shows the boiling performance comparison between TCMC and ABM coating for saturated water at pressure of 2.89 psia (Tₛₐₜ=60° C.). The boiling experiment data at Tₛₐₜ=60° C. are used considering electronic cooling applications such as computer chip cooling. Approximately 140% enhancement of nucleate boiling was achieved for TCMC compared to ABM coating surface. ABM coating showed only 15% enhancement over a plain sand-roughened surface. This means that the micro-size cavities formed in ABM coating are not sufficiently large enough to activate the nucleation boiling sites for water since water is a very poorly wetting liquid. In addition, TCMC provides additional ˜50% enhancement of CHF over ABM surface while CHF was enhanced only by ˜15% using ABM surface over the plain surface.

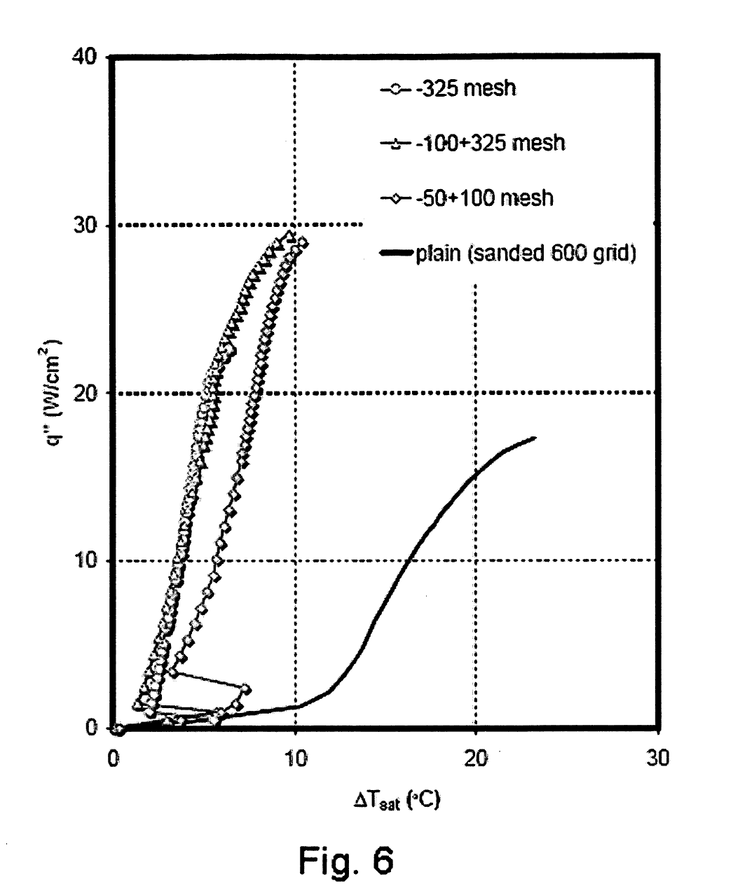

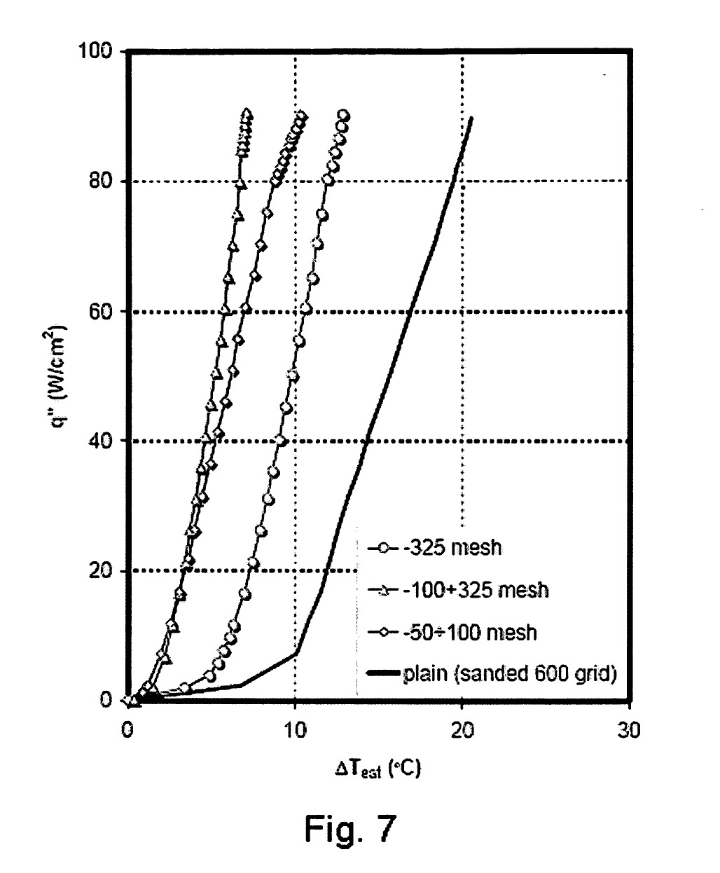

FIG. 6 illustrates the data produced in nucleate boiling heat transfer tests for the three embodiments described above and shown in FIGS. 1A, 1B and 1C in saturated FC-72. In addition, nucleate boiling curve of plain (sanded with 600 grids) surface is also shown for reference. Throughout the nucleate boiling regime, the three TCMC surfaces consistently augmented the heat transfer coefficients by up to ˜600% when compared to those of the plain surface. The boiling curves of 8-12 μm and 30-50 μm particles sizes collapsed in same line indicating about the same nucleate boiling enhancement for both cases. 100-200 μm showed slightly less enhancement of nucleate boiling heat transfer since the size of cavities are too large for FC-72. The CHF of 30-50 μm and 100-200 μm microporous coatings were approximately the same and ˜20% larger than that of microporous coating with 8-12 μm particles.

Boiling experiments in saturated water were performed at atmospheric pressure and the results are shown in FIG. 5. The boiling experiments were executed before reaching CHF due to the temperature limitation of heating element inside the test heater. The 30-50 μm and 100-200 μm particle sizes shows approximately the same nucleate boiling heat transfer coefficients at low heat flux region while the 30-50 μm shows better enhancement of nucleate boiling than 100-200 μm after ˜40 W/cm². The boiling curve of 8-12 μm showed that micro-pore sizes are too small compared to the other two cases illustrating much less nucleate boiling heat transfer enhancement.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks. Other variations and embodiments are possible in light of above teachings, and it is thus intended that the scope of invention not be limited by this Detailed Description, but rather by claims following.

We claim:

1. A composition, comprising:
cavity-generating particles;
a thermally conductive binder; and
a solvent.

2. The composition of claim 1, wherein the composition is applied to an electronic component surface.

3. The composition of claim 2, wherein the solvent is removed during application to the electronic component surface.

4. A method of coating a surface whereby enhancing the boiling properties of the surface comprising the steps:
creating a mixture comprising cavity-generating particles, a thermally conductive binder, and a solvent;
applying a layer of the mixture to a target surface;
heating the target surface, whereby the solvent is vaporized; and
further heating the target surface, whereby the thermally conductive binder is melted.

5. The method of claim 4, wherein the layer is applied to the target surface using a paintbrush.

6. The method of claim 4, wherein the mixture is mixed using an ultrasonic bath.

7. The method of claim 4, wherein the solvent comprises ethyl alcohol whereby the target surface is first heated to vaporize the solvent.

8. The method of claim 4, wherein the target surface comprises an electronic component.

9. A composition comprising cavity generating particles, a binder, and a carrier wherein the particle to binder ratio being about 1 gram to 0.5-0.8 grams and the carrier being about 10 ml per gram of particles.

10. The composition of claim 9, wherein the carrier is selected from the group comprising ethyl alcohol, isopropyl alcohol, acetone, methylethyl ketone, FC-72, or FC-87.

11. The composition of claim 9, wherein the binder is premixed solder paste.

12. The composition of claim 9, wherein the cavity generating particles are selected from the group comprising nickel, copper, aluminum, silver, iron, brass and alloys.

13. The composition of claim 9, wherein the cavity generating particles are 8-12 μm in size.

14. The composition of claim 9, wherein the cavity generating particles are 30-50 μm in size.

15. The composition of claim 9, wherein the cavity generating particles are 100-200 μm in size.

16. A composition of matter comprising carrier, binder, and cavity generating particles, wherein said composition of matter contains, in relative proportion:
about 10 ml carrier;
about 0.5 to 0.8 grams binder; and
about 1 gram of cavity generating particles.

17. The composition of claim 16, wherein the carrier is selected from the group comprising ethyl alcohol, isopropyl alcohol, acetone, methylethyl ketone, FC-72, or FC-87.

18. The composition of claim 16, wherein the binder is premixed solder paste.

19. The composition of claim 16, wherein the cavity generating particles are selected from the group comprising nickel, copper, aluminum, silver, iron, brass and alloys.

20. The composition of claim 16, wherein the cavity generating particles are 8-12 μm in size.

21. The composition of claim 16, wherein the cavity generating particles are 30-50 μm in size.

22. The composition of claim 16, wherein the cavity generating particles are 100-200 μm in size.

23. A method for surface enhancement to increase heat transfer of a surface in contact with a liquid, the method comprising applying to a surface the composition of claim 1.

24. The method of claim 23, wherein the composition is applied to the surface of an electronic chip.

25. An object to be immersed in a liquid coolant having a surface comprising cavity generating particles affixed by a binder such that boiling nucleation sites are formed in a density increasing critical heat flux of the surface.

26. The object of claim 25, wherein the cavity generating particles are selected from the group comprising nickel, copper, aluminum, silver, iron, brass and alloys.

27. The object of claim 25, wherein the cavity generating particles are 8-12 μm in size.

28. The object of claim 25, wherein the cavity generating particles are 30-50 μm in size.

29. The object of claim 25, wherein the cavity generating particles are 100-200 μm in size.

30. The object of claim 25, wherein the object is a microelectronic component.

31. The object of claim 25, wherein the object is a silicon chip.

32. The object of claim 25, wherein the liquid coolant is selected from the group comprising methanol, ethanol, fluorocarbons, water or FC-72.
